(19) United States
(12) Patent Application Publication
(10) Pub. No.: US 2025/0389931 A1
(43) Pub. Date: Dec. 25, 2025

(54) PROJECTION LENS ASSEMBLY

(71) Applicant: Asia Optical Co., Inc., Taichung (TW)

(72) Inventor: Chih-Peng Wang, Taichung (TW)

(21) Appl. No.: 19/199,467

(22) Filed: May 6, 2025

(30) Foreign Application Priority Data
Jun. 19, 2024 (TW) 113122668
Nov. 22, 2024 (CN) 202411685245.2

(51) Int. Cl. G02B 13/00; G02B 9/16

(52) U.S. Cl. CPC G02B 13/0035; G02B 9/16; G02B 13/0065

(57) ABSTRACT

A projection lens assembly includes a first lens, a second lens, and a third lens, all of which are arranged in order from a projection side to a light source side along an optical axis. The first lens is with positive refractive power and includes a convex surface facing the projection side. The second lens is with negative refractive power and includes a concave surface facing the projection side. The third lens is with positive refractive power and includes a convex surface facing the projection side.

### BACKGROUND OF THE INVENTION

### Field of the Invention

The present invention relates to a projection lens assembly.

### Description of the Related Art

The current development trend of a projection lens assembly is toward miniaturization and large field of view. Additionally, the projection lens assembly is developed to have a larger aperture to improve the brightness. However, the known projection lens assembly can't satisfy such requirements. Therefore, the projection lens assembly needs a new structure in order to meet the requirements of miniaturization, large field of view, and large aperture at the same time.

### BRIEF SUMMARY OF THE INVENTION

The invention provides a projection lens assembly to solve the above problems. The projection lens assembly of the invention is provided with characteristics of a decreased volume, an increased field of view, a decreased F-number, and still has a good optical performance.

The projection lens assembly in accordance with an exemplary embodiment of the invention includes a first lens, a second lens, and a third lens, all of which are arranged in order from a projection side to a light source side along an optical axis. The first lens is with positive refractive power and includes a convex surface facing the projection side. The second lens is with negative refractive power and includes a concave surface facing the projection side. The third lens is with positive refractive power and includes a convex surface facing the projection side. The projection lens assembly satisfies at least one of the following conditions: 18 mm≤f×TTL/HIMGH≤45 mm; 3 mm≤(f×f)/TR11R32≤11 mm; 0.6≤|(R11+R32)/f|≤5; TTL×f×f3<(FOV×BFL/f1)×(FOV+TR11R32); (f1/f)×3>fno; wherein f is an effective focal length of the projection lens assembly, f1 is an effective focal length of the first lens, f3 is an effective focal length of the third lens, TTL is an interval from a projection side surface of the first lens to a light source along the optical axis, BFL is an interval from a light source side surface of the third lens to the light source along the optical axis, HIMGH is a half image height of the projection lens assembly, TR11R32 is an interval from the projection side surface of the first lens to the light source side surface of the third lens along the optical axis, R11 is a radius of curvature of the projection side surface of the first lens, R32 is a radius of curvature of the light source side surface of the third lens, FOV is a field of view of the projection lens assembly, and fno is a F-number of the projection lens assembly. The basic functions of the projection lens assembly of the present invention can be achieved when the projection lens assembly of the present invention satisfies the above features and at least one of the conditions, and does not require other additional features or conditions.

In another exemplary embodiment, the projection lens assembly satisfies at least one of following conditions: 0.6≤f1/f≤2.6; 0.3≤f3/f≤3.9; 0.7≤f1/f3≤5.1; 0.4≤BFL/f≤1.3; 0.3≤BFL/TTL≤0.8; 0.9≤TTL/f≤2.5; 0.4≤(f×TTL)/(f1×f3)≤ 2.6; wherein f is the effective focal length of the projection lens assembly, f1 is the effective focal length of the first lens, f3 is the effective focal length of the third lens, TTL is the interval from the projection side surface of the first lens to the light source along the optical axis, BFL is the interval from the light source side surface of the third lens to the light source along the optical axis.

In yet another exemplary embodiment, at least one of the first lens, the second lens, and the third lens is a meniscus lens; the first lens is a meniscus lens when the number of meniscus lenses is one; the second lens and the third lens are meniscus lenses when the number of meniscus lenses is two; and the first lens, the second lens and the third lens are meniscus lenses when the number of meniscus lenses is three.

In another exemplary embodiment, the first lens is a biconvex lens and further comprises another convex surface facing the light source side when the number of meniscus lenses is two.

In yet another exemplary embodiment, the second lens is a biconcave lens and further comprises another concave surface facing the light source side and the third lens is a biconvex lens and further comprises another convex surface facing the light source side when the number of meniscus lenses is one.

In another exemplary embodiment, the convex surface of the third lens has an inflection point when the number of meniscus lenses is three; and a light source side surface of the first lens has an inflection point, a light source side surface of the second lens has an inflection point, and a light source side surface of the third lens has an inflection point when the number of meniscus lenses is one.

In yet another exemplary embodiment, the projection lens assembly further includes a light deflection element disposed between the third lens and the light source side, wherein the light deflection element is a polarization beam prism, a beam combining prism, a polygonal prism, a curved mirror, or a reflective mirror.

In another exemplary embodiment, the projection lens assembly further includes at least a light source: the light source is disposed on a side of the light deflection element which is far away from the optical axis or another side of the light deflection element which is far away from the third lens when the number of light sources is one; the light sources are separated by the light deflection element and disposed away from the optical axis when the number of light sources is two and the light sources are parallel to each other; one of the light sources is disposed on the side of the light deflection element which is away from the optical axis, the other of the light sources is disposed on the another side of the light deflection element which is away from the third lens when the number of light sources is two and the light sources are perpendicular to each other; and one of the light sources is disposed on the another side of the light deflection element which is away from the third lens, the other two of the light sources are parallel to each other, and separated by the light deflection element and disposed away from the optical axis when the number of light sources is three.

In yet another exemplary embodiment, the lens assembly further includes a stop disposed between the projection side and the first lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a projection lens assembly in accordance with a second embodiment of the invention;

FIGS. 2A and 2B depict a field curvature diagram and a distortion diagram of the projection lens assembly in accordance with the second embodiment of the invention, respectively;

FIG. 3 depicts a modulation transfer function diagram of the projection lens assembly in accordance with the second embodiment of the invention;

FIG. 4 is a lens layout and optical path diagram of a projection lens assembly in accordance with a third embodiment of the invention;

FIGS. 5A and 5B depict a field curvature diagram and a distortion diagram of the projection lens assembly in accordance with the third embodiment of the invention, respectively;

FIG. 6 depicts a modulation transfer function diagram of the projection lens assembly in accordance with the third embodiment of the invention;

FIG. 7 is a lens layout and optical path diagram of a projection lens assembly in accordance with a fourth embodiment of the invention;

FIGS. 8A and 8B depict a field curvature diagram and a distortion diagram of the projection lens assembly in accordance with the fourth embodiment of the invention, respectively;

FIG. 9 depicts a modulation transfer function diagram of the projection lens assembly in accordance with the fourth embodiment of the invention;

FIG. 10 is a lens layout and optical path diagram of a projection lens assembly in accordance with a fifth embodiment of the invention;

FIGS. 11A and 11B depict a field curvature diagram and a distortion diagram of the projection lens assembly in accordance with the fifth embodiment of the invention, respectively;

FIG. 12 depicts a modulation transfer function diagram of the projection lens assembly in accordance with the fifth embodiment of the invention;

FIG. 13 is a lens layout and optical path diagram of a projection lens assembly in accordance with a sixth embodiment of the invention;

FIGS. 14A and 14B depict a field curvature diagram and a distortion diagram of the projection lens assembly in accordance with the sixth embodiment of the invention, respectively;

FIG. 15 depicts a modulation transfer function diagram of the projection lens assembly in accordance with the sixth embodiment of the invention;

FIG. 16 is a lens layout and optical path diagram of a projection lens assembly in accordance with a seventh embodiment of the invention;

FIGS. 17A and 17B depict a field curvature diagram and a distortion diagram of the projection lens assembly in accordance with the seventh embodiment of the invention, respectively;

FIG. 18 depicts a modulation transfer function diagram of the projection lens assembly in accordance with the seventh embodiment of the invention;

FIG. 19 is a lens layout and optical path diagram of a projection lens assembly in accordance with an eighth embodiment of the invention;

FIGS. 20A and 20B depict a field curvature diagram and a distortion diagram of the projection lens assembly in accordance with the eighth embodiment of the invention, respectively; and

FIG. 21 depicts a modulation transfer function diagram of the projection lens assembly in accordance with the eighth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

A first embodiment of the projection lens assembly of the present invention is described in detail below. The projection lens assembly includes a first lens, a second lens, and a third lens. The first lens is with positive refractive power and includes a convex surface facing a projection side and a convex surface, a concave surface, or a plane surface facing a light source side. The second lens is with negative refractive power and includes a concave surface facing the projection side and a convex surface, a concave surface, or a plane surface facing the light source side, which helps to correct the aberration of the third lens. The third lens is with positive refractive power and includes a convex surface facing the projection side and a convex surface, a concave surface, or a plane surface facing the light source side. The first lens, the second lens, and the third lens are arranged in order from the projection side to the light source side long an optical axis. The materials of the above three lenses can be plastic or glass and the design of the refractive power for the above three lenses helps to correct basic aberrations such as field curvature and spherical aberration. When the projection lens assembly only satisfies the condition 0.6≤f1/f≤2.6, the basic operation can be achieved; or when the projection lens assembly only satisfies the condition 0.7≤f1/f3<5.1, the basic operation can be achieved; or when the projection lens assembly only satisfies the condition 0.3≤f3/f≤3.9, the basic operation can be achieved; or when the projection lens assembly only satisfies the condition 0.4<BFL/f≤1.3, the basic operation can be achieved; or when the projection lens assembly only satisfies the condition 0.3≤BFL/TTL≤0.8, the basic operation can be achieved; or when the projection lens assembly only satisfies the condition: 0.9≤TTL/f≤2.5, the basic operation can be achieved; or when the projection lens assembly only satisfies the condition 0.4≤(fxTTL)/(f1×f3)≤2.6, the basic operation can be achieved; or when the projection lens assembly only satisfies the condition of 18 mm≤fxTTL/HIMGH≤45 mm, the basic operation can be achieved; or when the projection lens assembly only satisfies the condition 3 mm≤(fxf)/TR11R32≤11 mm, the basic actuation can be achieved; or when the projection lens assembly only satisfies the condition 0.6≤|(R11+R32)/f|≤5, the basic operation can be achieved; or when the projection lens assembly only satisfies the condition TTLxfxf3< (FOV×BFL/f1)×(FOV+TR11R32), the basic operation can be achieved; or when the projection lens assembly only satisfies the condition (f1/f)×3>fno, the basic operation can be achieved; or when the projection lens assembly only satisfies the condition TR11R32/2>TR12R21/log (f)>TR12R21, the basic operation can be achieved; wherein f is an effective focal length of the projection lens assembly, f1 is an effective focal length of the first lens, f3 is an effective focal length of the third lens, TTL is an interval from a projection side surface of the first lens to a light source along an optical axis, BFL is an interval from a light source side surface of the third lens to the light source along the optical axis, HIMGH is a half image height of the projection lens assembly, TR11R32 is an interval from the projection side surface of the first lens to the light source side surface of the third lens along the optical axis, R11 is a radius of curvature of the projection side surface of the first lens, R32 is a radius of curvature of the light source side surface of the third lens, FOV is a field of view of the projection lens assembly, fno is a F-number of the projection lens assembly, and TR12R21 is an interval from a light source side surface of the first lens to a projection side surface of the second lens along the optical axis. The units of f, f1, f2, f3, TR11R32, TTL, BFL, and TR12R21 are the same, for example, they can be length units such as mm or cm.

Referring to Table 1, Table 2, Table 4, Table 5, Table 7, Table 8, Table 10, Table 11, Table 13, Table 14, Table 17, Table 18, Table 20, and Table 21, wherein Table 1, Table 4, Table 7, Table 10, Table 13, Table 17, and Table 20 show optical specification in accordance with a second, a third, a fourth, a fifth, a sixth, a seventh, and an eighth embodiments of the invention, respectively, and Table 2, Table 5, Table 8, Table 11, Table 14, Table 18, and Table 21 show aspheric coefficients of each aspheric lens in Table 1, Table 4, Table 7, Table 10, Table 13, Table 17, and Table 20, respectively.

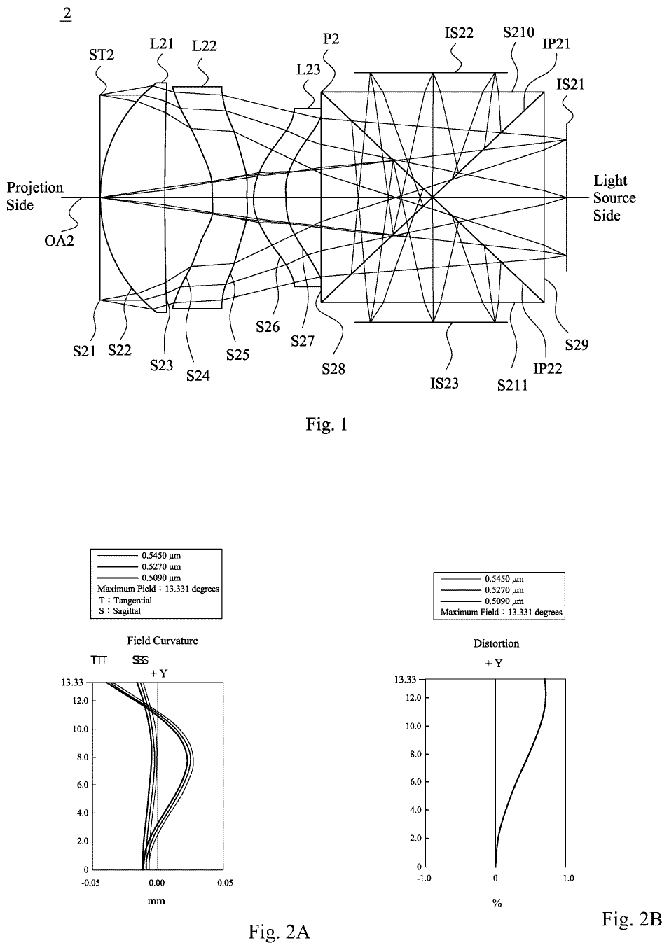

FIGS. 1, 4, 7, 10, 13, 16, and 19 are lens layout and optical path diagrams of the projection lens assemblies in accordance with the second, third, fourth, fifth, sixth, seventh, and eighth embodiments of the invention, respectively.

The first lenses L21, L31, L41, L51, L61, L71, L81 are with positive refractive power, wherein the projection side surfaces S22, S32, S42, S52, S62, S72, S82 are convex surfaces and both of the projection side surfaces S22, S32, S42, S52, S62, S72, S82 and light source side surfaces S23, S33, S43, S53, S63, S73, S83 are aspheric surfaces.

The second lenses L22, L32, L42, L52, L62, L72, L82 are with negative refractive power, wherein the projection side surfaces S24, S34, S44, S54, S64, S74, S84 are concave surfaces and both of the projection side surfaces S24, S34, S44, S54, S64, S74, S84 and light source side surfaces S25, S35, S45, S55, S65, S75, S85 are aspheric surfaces.

The third lenses L23, L33, L43, L53, L63, L73, L83 are with positive refractive power, wherein the projection side surfaces S26, S36, S46, S56, S66, S76, S86 are convex surfaces and both of the projection side surfaces S26, S36, S46, S56, S66, S76, S86 and light source side surfaces S27, S37, S47, S57, S67, S77, S87 are aspheric surfaces.

In addition, the projection lens assemblies 2, 3, 4, 5, 6, 7, and 8 satisfy at least one of the following conditions (1)-(13):

$$0.6 \leq f 1 / f \leq 2.6 ; \qquad ( 1 )$$

$$0.7 \leq f 1 / f 3 \leq 5.1 ; \qquad ( 2 )$$

$$0.3 \leq f 3 / f \leq 3.9 ; \qquad ( 3 )$$

$$0.4 \leq BFL / f \leq 1.3 ; \qquad ( 4 )$$

$$0.3 \leq BFL / TTL \leq 0.8 ; \qquad ( 5 )$$

$$0.9 \leq TTL / f \leq 2.5 ; \qquad ( 6 )$$

$$0.4 \leq ( f \times TTL ) / ( f 1 \times f 3 ) \leq 2.6 ; \qquad ( 7 )$$

$$18 mm \leq f \times TTL / HIMGH \leq 45 mm \qquad ( 8 )$$

$$3 mm \leq ( f \times f ) / TR 11 R 32 \leq 11 mm \qquad ( 9 )$$

$$0.6 \leq \vert ( R 11 + R 32 ) / f \vert \leq 5 \qquad ( 10 )$$

$$TTL \times f \times f 3 < ( FOV \times BFL / f 1 ) \times ( FOV + TR 11 R 32 ) \qquad ( 11 )$$

$$( f 1 / f ) \times 3 > fno \qquad ( 12 )$$

$$TR 11 R 32 / 2 > TR 12 R 21 / log ( f ) > TR 12 R 21 \qquad ( 13 )$$

wherein: f is an effective focal length of the projection lens assemblies 2, 3, 4, 5, 6, 7, 8 for the second to eighth embodiments; f1 is an effective focal length of the first lenses L21, L31, L41, L51, L61, L71, L81 for the second to eighth embodiments; f3 is an effective focal length of the third lenses L23, L33, L43, L53, L63, L73, L83 for the second to eighth embodiments; TTL is an interval from the projection side surfaces S22, S32, S42, S52, S62, S72, S82 of the first lenses L11, L21, L31, L41, L51, L61, L71, L81 to the light sources IS21, IS31, IS41, IS51, IS61, IS71, IS81 along the optical axes OA2, OA3, OA4, OA5, OA6, OA7, OA8 for the second to eighth embodiments; BFL is an interval from the light source side surfaces S27, S37, S47, S57, S67, S77, S87 of the third lenses L23, L33, L43, L53, L63, L73, L83 to the light sources IS21, IS31, IS41, IS51, IS61, IS71, IS81 along the optical axes OA2, OA3, OA4, OA5, OA6, OA7, OA8 for the second to eighth embodiments; HIMGH is a half image height of the projection lens assemblies 2, 3, 4, 5, 6, 7, 8 for the second to eighth embodiments; TR11R32 is an interval from the projection side surfaces S22, S32, S42, S52, S62, S72, S82 of the first lenses L11, L21, L31, L41, L51, L61, L71, L81 to the light source side surfaces S27, S37, S47, S57, S67, S77, S87 of the third lenses L23, L33, L43, L53, L63, L73, L83 along the optical axes OA2, OA3, OA4, OA5, OA6, OA7, OA8 for the second to eighth embodiments; R11 is a radius of curvature of the projection side surfaces S22, S32, S42, S52, S62, S72, S82 of the first lenses L11, L21, L31, L41, L51, L61, L71, L81 for the second to eighth embodiments; R32 is a radius of curvature of the light source side surfaces S27, S37, S47, S57, S67, S77, S87 of the third lenses L13, L23, L33, L43, L53, L63, L73, L83 for the second to eighth embodiments; FOV is a field of view of the projection lens assemblies 2, 3, 4, 5, 6, 7, 8 for the second to eighth embodiments; fno is a F-number of the projection lens assemblies 2, 3, 4, 5, 6, 7, 8 for the second to eighth embodiments; and TR12R21 is an interval from the light source side surfaces S23, S33, S43, S53, S63, S73, S83 of the first lenses L11, L21, L31, L41, L51, L61, L71, L81 to the projection side surfaces S24, S34, S44, S54, S64, S74, S84 of the second lenses L22, L32, L42, L52, L62, L72, L82 along the optical axes OA2, OA3, OA4, OA5, OA6, OA7, OA8 for the second to eighth embodiments. With the projection lens assemblies 2, 3, 4, 5, 6, 7, 8 satisfying at least one of the above conditions (1)-(13), the field of view can be effectively increased, the volume can be effectively decreased, the F-number can be effectively decreased, the resolution can be effectively increased, the aberration can be effectively corrected, and the light transmission efficiency and overall brightness can be effectively increased and the energy can be effectively saved.

A detailed description of a projection lens assembly in accordance with a second embodiment of the invention is as follows. Referring to FIG. 1, the projection lens assembly 2 includes a stop ST2, a first lens L21, a second lens L22, a third lens L23, and a light deflection element P2, all of which are arranged in order from a projection side to a light source side along an optical axis OA2. The light deflection element P2 includes a first incident surface S29, a second incident surface S210, a third incident surface S211, an exit surface S28, a first inclined surface IP21, and a second inclined surface IP22. In operation, the lights from the light sources IS21, IS22, and IS23 enter the light deflection element P2 from the first incident surface S29, the second incident surface S210, and the third incident surface S211, respectively. The light from the light source IS21 directly penetrates the first inclined surface IP21 and the second inclined surface IP22, the light from the light source IS22 is reflected by the first inclined surface IP21 and can penetrate the second inclined surface IP22, the light from the light source IS23 is reflected by the second inclined surface IP22 and can penetrate the first inclined surface IP21. The lights from the first light source IS21, the second light source IS22, and the third light source IS23 finally all exit the light deflection element P2 from the exit surface S28, that is, the lights from the first light source IS21, the second light source IS22, and the third light source IS23 are combined and then exit the light deflection element P2 from the exit surface S28, then enter the third lens L23, and finally are projected on a screen (not shown). The light deflection element P2 mentioned above is a prism. The light source IS21 is disposed on a side of the light deflection element P2 which is away from the third lens L23. The light source IS22 and the light source IS23 are separated from each other by the light deflection element P2 and disposed away from the optical axis OA2. The light source IS21 is perpendicular to the light source IS22 and also perpendicular to the light source IS23. The light source IS22 and the light source IS23 are parallel to each other.

According to the foregoing, wherein: the first lens L21 is a meniscus lens, wherein the light source side surface S23 is a concave surface; the second lens L22 is a meniscus lens, wherein the light source side surface S25 is a convex surface; the third lens L23 is a meniscus lens, wherein the light source side surface S27 is a concave surface; the first incident surface S29, the second incident surface S210, the third incident surface S211, the exit surface S28, the first inclined surface IP21, and the second inclined surface IP22 of the light deflection element P2 are all plane surfaces; and the projection side surface S26 of the third lens L23 includes two inflection points. With the above design and at least one of the conditions (1)-(13) are satisfied, the projection lens assembly 2 can have an effective increased field of view, an effective decreased volume, an effective decreased F-number, an effective increased resolution, an effective corrected aberration, and an effective increased the light transmission efficiency and overall brightness and saved the energy.

Table 1 shows the optical specification of the projection lens assembly 2 in FIG. 1.

TABLE 1
Effective Focal Length = 5.299 mm F-number = 1.519
Total Lens Length = 7.485 mm Field of View = 26.200 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S21 | ∞ | 0 | | | | ST2 |
| S22 | 2.475860363 | 1.0349 | 1.545 | 55.987 | 5.166 | L21 |
| S23 | 16.80734746 | 0.7812 | | | | |
| S24 | −1.287801 | 0.5533 | 1.661 | 20.401 | −6.095 | L22 |
| S25 | −2.202236396 | 0.1000 | | | | |
| S26 | 1.161761562 | 0.5023 | 1.545 | 55.987 | 6.129 | L23 |
| S27 | 1.504046006 | 0.5704 | | | | |
| S28 | ∞ | 3.6000 | 1.517 | 64.167 | | P2 |
| S29 | ∞ | 0.3431 | | | | |

The aspheric surface sag z of each aspheric surface in Table 1 can be calculated by the following formula:

$$z = c {h}^{2} / \{ 1 + {[ 1 - ( k + 1 ) {c}^{2} {h}^{2} ]}^{1 / 2} \} + A {h}^{4} + B {h}^{6} + C {h}^{8} + D {h}^{10}$$

where c is curvature, h is the vertical distance from the lens surface to the optical axis, k is conic constant and A, B, C, and D are aspheric coefficients.

In the first embodiment, the conic constant k and the aspheric coefficients A, B, C, D of each aspheric lens are shown in Table 2.

TABLE 2

| Surface | | | | | |
|---|---|---|---|---|---|
| Number | k | A | B | C | D |
| S22 | −1.308 | 5.2479E−03 | 5.6890E−04 | 1.3080E−04 | 3.1888E−05 |
| S23 | −100.000 | −2.8381E−02 | 1.1436E−02 | −1.8798E−03 | 1.3776E−04 |
| S24 | −2.325 | 4.7781E−02 | −1.2801E−02 | 1.6400E−03 | −3.2841E−05 |
| S25 | −2.402 | 2.4778E−02 | 1.2736E−03 | −2.3556E−03 | 4.3614E−04 |
| S26 | −1.333 | 2.5160E−02 | −1.4623E−02 | −1.6074E−02 | 4.0838E−03 |
| S27 | −0.310 | 7.8208E−02 | −1.0059E−01 | 1.6025E−02 | −2.7477E−04 |

Table 3 shows the parameters and condition values for conditions (1)-(13) in accordance with the second embodiment of the invention. It can be seen from Table 3 that the projection lens assembly 2 of the second embodiment satisfies the conditions (1)-(13).

TABLE 3

| BFL | 4.5135 mm | HIMGH | 1.260 | mm | TR11R32 | 2.9716 | mm |
|---|---|---|---|---|---|---|---|
| f1/f | 0.97 | f1/f3 | 0.84 | | f3/f | 1.16 | |
| BFL/f | 0.85 | BFL/TTL | 0.60 | | TTL/f | 1.41 | |
| (f × TTL)/(f1 × f3) | 1.25 | f × TTL/HIMGH | 31.48 | mm | (f × f)/TR11R32 | 9.45 | mm |

| \|(R11 + R32)/f\| | 0.75 | TTL × f × f3 | 243.10 | (FOV × BFL/f1) × | 667.81 |
|---|---|---|---|---|---|
| | | | | (FOV + TR11R32) | |
| TR12R21/log(f) | 1.079 | TR12R21 | 0.781 | | |

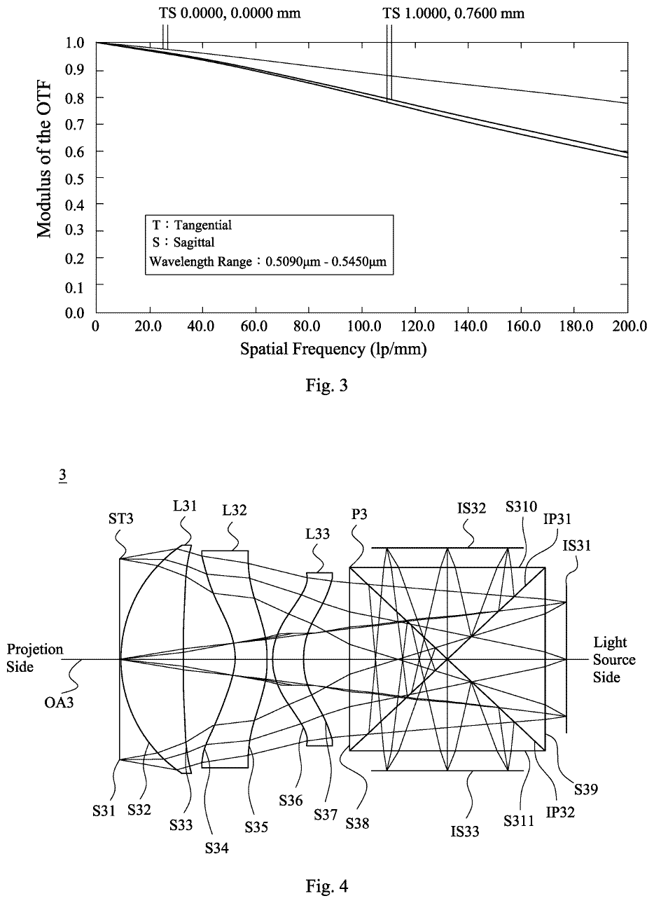

In addition, the projection lens assembly 2 of the second embodiment can meet the requirements of optical performance. It can be seen from FIGS. 2A and 2B that the field curvature of tangential direction and sagittal direction ranges from −0.04 mm to 0.03 mm and the distortion ranges from 0% to 0.8% for the projection lens assembly 2 of the second embodiment. It can be seen from FIG. 3 that the modulation transfer function ranges from 0.58 to 1.0 for the projection lens assembly 2 of the second embodiment. It is obvious that the field curvature and the distortion can be corrected effectively and the resolution can also meet the requirements for the projection lens assembly 2 of the second embodiment. Therefore, the projection lens assembly 2 of the second embodiment is capable of good optical performance.

A detailed description of a projection lens assembly in accordance with a third embodiment of the invention is as follows. Referring to FIG. 4, the projection lens assembly 3 includes a stop ST3, a first lens L31, a second lens L32, a third lens L33, and a light deflection element P3, all of which are arranged in order from a projection side to a light source side along an optical axis OA3. The light deflection element P3 includes a first incident surface S39, a second incident surface S310, a third incident surface S311, an exit surface S38, a first inclined surface IP31, and a second inclined surface IP32. In operation, the lights from the light sources IS31, IS32, and IS33 enter the light deflection element P3 from the first incident surface S39, the second incident surface S310, and the third incident surface S311, respectively. The light from the light source IS31 directly penetrates the first inclined surface IP31 and the second inclined surface IP32, the light from the light source IS32 is reflected by the first inclined surface IP31 and can penetrate the second inclined surface IP32, the light from the light source IS33 is reflected by the second inclined surface IP32 and can penetrate the first inclined surface IP31. The lights from the first light source IS31, the second light source IS32, and the third light source IS33 finally all exit the light deflection element P3 from the exit surface S38, that is, the lights from the first light source IS31, the second light source IS32, and the third light source IS33 are combined and then exit the light deflection element P3 from the exit surface S38, then enter the third lens L33, and finally are projected on a screen (not shown). The light deflection element P3 mentioned above is a prism.

According to the foregoing, wherein: the first lens L31 is a meniscus lens, wherein the light source side surface S33 is a concave surface; the second lens L32 is a meniscus lens, wherein the light source side surface S35 is a convex surface; the third lens L33 is a meniscus lens, wherein the light source side surface S37 is a concave surface; the first incident surface S39, the second incident surface S310, the third incident surface S311, the exit surface S38, the first inclined surface IP31, and the second inclined surface IP32 of the light deflection element P3 are all plane surfaces; the light source side surface S35 of the second lens L32 includes two inflection points; the projection side surface S36 and light source side surface S37 of the third lens L33 includes two inflection points, respectively. With the above design and at least one of the conditions (1)-(13) are satisfied, the projection lens assembly 3 can have an effective increased field of view, an effective decreased volume, an effective decreased F-number, an effective increased resolution, an effective corrected aberration, and an effective increased the light transmission efficiency and overall brightness and saved the energy.

Table 4 shows the optical specification of the projection lens assembly 3 in FIG. 4.

TABLE 4
Effective Focal Length = 5.299 mm F-number = 1.523
Total Lens Length = 7.323 mm Field of View = 26.400 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S31 | ∞ | 0 | | | | ST3 |
| S32 | 2.34508 | 1.04124 | 1.545 | 55.987 | 5.183 | L31 |
| S33 | 11.32963 | 0.85367 | | | | |
| S34 | −1.16994 | 0.51813 | 1.661 | 20.401 | −5.486 | L32 |
| S35 | −2.01833 | 0.10000 | | | | |
| S36 | 1.12074 | 0.50000 | 1.545 | 55.987 | 5.501 | L33 |
| S37 | 1.50201 | 0.76721 | | | | |
| S38 | ∞ | 3.2000 | 1.517 | 64.167 | | P3 |
| S39 | ∞ | 0.3428 | | | | |

The definition of aspheric surface sag z of each aspheric surface in Table 4 is the same as that of in Table 1, and is not described here again.

In the third embodiment, the conic constant k and the aspheric coefficients A, B, C, D of each aspheric lens are shown in Table 5.

TABLE 5

| Surface | | | | | |
|---|---|---|---|---|---|
| Number | k | A | B | C | D |
| S32 | −1.319 | 5.6648E−03 | 2.2738E−03 | −1.1654E−04 | 2.4955E−05 |
| S33 | −77.573 | −2.0335E−02 | 1.3580E−02 | −3.6672E−03 | 4.0660E−04 |
| S34 | −3.480 | 4.2057E−02 | −1.3958E−02 | 2.6626E−03 | −1.1339E−04 |
| S35 | −6.829 | 1.1078E−02 | 3.5688E−03 | −2.3047E−03 | 5.4155E−04 |
| S36 | −1.735 | 3.2726E−02 | −2.8020E−02 | −1.1421E−02 | 3.4371E−03 |
| S37 | −1.297 | 7.0477E−02 | −8.8699E−02 | 1.7039E−02 | −1.2980E−04 |

Table 6 shows the parameters and condition values for conditions (1)-(13) in accordance with the third embodiment of the invention. It can be seen from Table 6 that the projection lens assembly 3 of the third embodiment satisfies the conditions (1)-(13).

TABLE 6

| BFL | 4.3101 mm | HIMGH | 1.260 | mm | TR11R32 | 3.0130 | mm |
|---|---|---|---|---|---|---|---|
| f1/f | 0.98 | f1/f3 | 0.94 | | f3/f | 1.04 | |
| BFL/f | 0.81 | BFL/TTL | 0.59 | | TTL/f | 1.38 | |
| (f × TTL)/(f1 × f3) | 1.36 | f × TTL/HIMGH | 30.80 | mm | (f × f)/TR11R32 | 9.32 | mm |

| \|(R11 + R32)/f\| | 0.73 | TTL × f × f3 | 213.48 | (FOV × BFL/f1) × | 645.74 |
|---|---|---|---|---|---|
| | | | | (FOV + TR11R32) | |
| TR12R21/log(f) | 1.179 | TR12R21 | 0.854 | | |

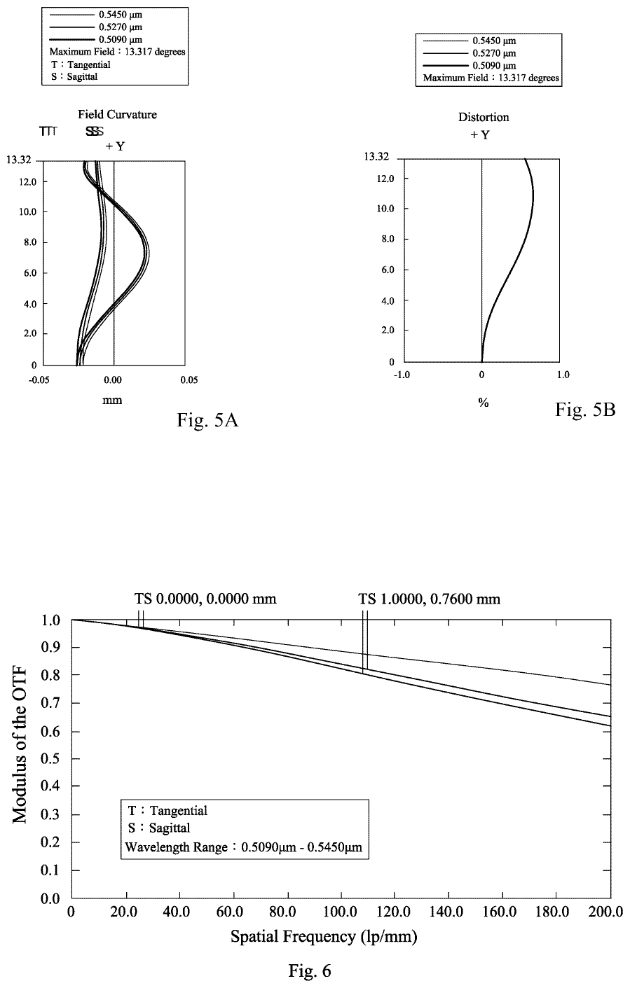

In addition, the projection lens assembly 3 of the third embodiment can meet the requirements of optical performance. It can be seen from FIGS. 5A and 5B that the field curvature of tangential direction and sagittal direction ranges from −0.03 mm to 0.03 mm and the distortion ranges from 0% to 0.7% for the projection lens assembly 3 of the third embodiment. It can be seen from FIG. 6 that the modulation transfer function ranges from 0.62 to 1.0 for the projection lens assembly 3 of the third embodiment. It is obvious that the field curvature and the distortion can be corrected effectively and the resolution can also meet the requirements for the projection lens assembly 3 of the third embodiment. Therefore, the projection lens assembly 3 of the third embodiment is capable of good optical performance.

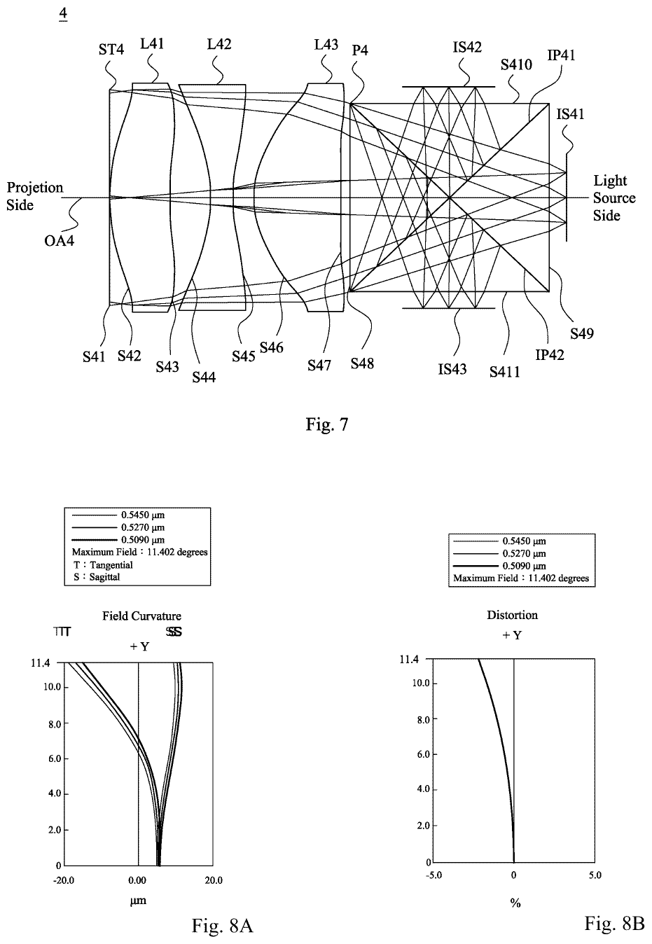

A detailed description of a projection lens assembly in accordance with a fourth embodiment of the invention is as follows. Referring to FIG. 7, the projection lens assembly 4 includes a stop ST4, a first lens L41, a second lens LA2, a third lens L43, and a light deflection element P4, all of which are arranged in order from a projection side to a light source side along an optical axis OA4. The light deflection element P4 includes a first incident surface S49, a second incident surface S410, a third incident surface S411, an exit surface S48, a first inclined surface IP41, and a second inclined surface IP42. In operation, the lights from the light sources IS41, IS42, and IS43 enter the light deflection element P4 from the first incident surface S49, the second incident surface S410, and the third incident surface S411, respectively. The light from the light source IS41 directly penetrates the first inclined surface IP41 and the second inclined surface IP42, the light from the light source IS42 is reflected by the first inclined surface IP41 and can penetrate the second inclined surface IP42, the light from the light source IS43 is reflected by the second inclined surface IP42 and can penetrate the first inclined surface IP41. The lights from the first light source IS41, the second light source IS42, and the third light source IS43 finally all exit the light deflection element P4 from the exit surface S48, that is, the lights from the first light source IS41, the second light source IS42, and the third light source IS43 are combined and then exit the light deflection element P4 from the exit surface S48, then enter the third lens L43, and finally are projected on a screen (not shown). The light deflection element P4 mentioned above is a prism.

According to the foregoing, wherein: the first lens L41 is a meniscus lens, wherein the light source side surface S43 is a concave surface; the second lens L42 is a biconcave lens, wherein the light source side surface S45 is a concave surface; the third lens L43 is a biconvex lens, wherein the light source side surface S47 is a convex surface; the first incident surface S49, the second incident surface S410, the third incident surface S411, the exit surface S48, the first inclined surface IP41, and the second inclined surface IP42 of the light deflection element P4 are all plane surfaces; the light source side surface S43 of the first lens L41 includes two inflection points; the light source side surface S45 of the second lens LA2 includes two inflection points; the light source side surface S47 of the third lens LA3 includes two inflection points. With the above design and at least one of the conditions (1)-(13) are satisfied, the projection lens assembly 4 can have an effective increased field of view, an effective decreased volume, an effective decreased F-number, an effective increased resolution, an effective corrected aberration, and an effective increased the light transmission efficiency and overall brightness and saved the energy.

Table 7 shows the optical specification of the projection lens assembly 4 in FIG. 7.

TABLE 7
Effective Focal Length = 3.880 mm F-number = 0.970
Total Lens Length = 8.000 mm Field of View = 24.800 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S41 | ∞ | 0 | | | | ST4 |
| S42 | 3.69369 | 1.05484 | 1.851 | 40.104 | 8.370 | L41 |
| S43 | 6.59272 | 0.70913 | | | | |
| S44 | −2.76026 | 0.40000 | 1.661 | 20.401 | −2.090 | L42 |
| S45 | 3.03111 | 0.36304 | | | | |
| S46 | 1.66492 | 1.52298 | 1.882 | 37.221 | 1.790 | L43 |
| S47 | −21.32415 | 0.15000 | | | | |
| S48 | ∞ | 3.5000 | 1.517 | 64.167 | | P4 |
| S49 | ∞ | 0.3000 | | | | |

The definition of aspheric surface sag z of each aspheric surface in Table 7 is the same as that of in Table 1, and is not described here again.

In the fourth embodiment, the conic constant k and the aspheric coefficients A, B, C, D of each aspheric lens are shown in Table 8.

TABLE 8

| Surface | | | | | |
|---|---|---|---|---|---|
| Number | k | A | B | C | D |
| S42 | −9.998 | 1.4289E−02 | −4.2433E−03 | 6.3236E−04 | −9.2091E−05 |
| S43 | −36.221 | −8.0365E−03 | 7.2449E−04 | −8.4702E−04 | 9.9456E−05 |
| S44 | −0.485 | 2.3328E−02 | −2.8322E−03 | −5.9189E−05 | 7.4571E−05 |
| S45 | −21.310 | −6.6286E−03 | 4.0620E−04 | −6.9955E−04 | 2.3350E−04 |
| S46 | −4.080 | 2.5770E−02 | −5.1590E−03 | 1.0432E−03 | −1.6128E−04 |
| S47 | 0.000 | 1.9908E−02 | 2.0436E−03 | −1.8617E−03 | 1.5912E−04 |

Table 9 shows the parameters and condition values for conditions (1)-(13) in accordance with the fourth embodiment of the invention. It can be seen from Table 9 that the projection lens assembly 4 of the fourth embodiment satisfies the conditions (1)-(13).

TABLE 9

| BFL | 3.9500 mm | HIMGH | 0.830 | mm | TR11R32 | 4.0500 | mm |
|---|---|---|---|---|---|---|---|
| f1/f | 2.16 | f1/f3 | 4.68 | | f3/f | 0.46 | |
| BFL/f | 1.02 | BFL/TTL | 0.49 | | TTL/f | 2.06 | |
| (f × TTL)/(f1 × f3) | 2.07 | f × TTL/HIMGH | 37.40 | mm | (f × f)/TR11R32 | 3.72 | mm |

| \|(R11 + R32)/f\| | 4.54 | TTL × f × f3 | 55.55 | (FOV × BFL/f1) × | 337.66 |
|---|---|---|---|---|---|
| | | | | (FOV + TR11R32) | |
| TR12R21/log(f) | 1.204 | TR12R21 | 0.709 | | |

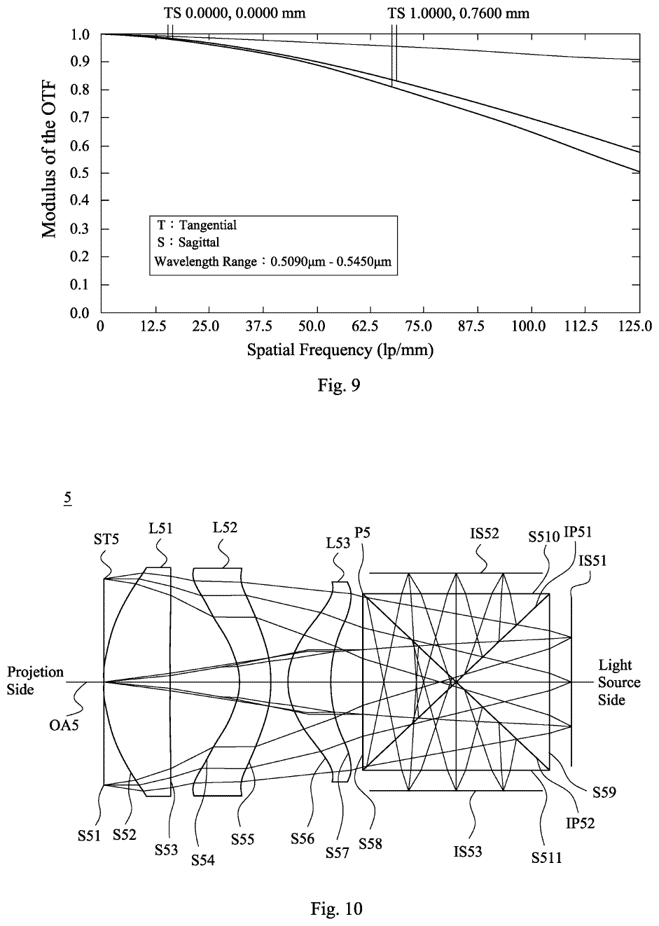

In addition, the projection lens assembly 4 of the fourth embodiment can meet the requirements of optical performance. It can be seen from FIGS. 8A and 8B that the field curvature of tangential direction and sagittal direction ranges from −20 μm to 12 μm and the distortion ranges from −2.5% to 0% for the projection lens assembly 4 of the fourth embodiment. It can be seen from FIG. 9 that the modulation transfer function ranges from 0.50 to 1.0 for the projection lens assembly 4 of the fourth embodiment. It is obvious that the field curvature and the distortion can be corrected effectively and the resolution can also meet the requirements for the projection lens assembly 4 of the fourth embodiment. Therefore, the projection lens assembly 4 of the fourth embodiment is capable of good optical performance.

A detailed description of a projection lens assembly in accordance with a fifth embodiment of the invention is as follows. Referring to FIG. 10, the projection lens assembly 5 includes a stop ST5, a first lens L51, a second lens L52, a third lens L53, and a light deflection element P5, all of which are arranged in order from a projection side to a light source side along an optical axis OA5. The light deflection element P5 includes a first incident surface S59, a second incident surface S510, a third incident surface S511, an exit surface S58, a first inclined surface IP51, and a second inclined surface IP52. In operation, the lights from the light sources IS51, IS52, and IS53 enter the light deflection element P5 from the first incident surface S59, the second incident surface S510, and the third incident surface S511, respectively. The light from the light source IS51 directly penetrates the first inclined surface IP51 and the second inclined surface IP52, the light from the light source IS52 is reflected by the first inclined surface IP51 and can penetrate the second inclined surface IP52, the light from the light source IS53 is reflected by the second inclined surface IP52 and can penetrate the first inclined surface IP51. The lights from the first light source IS51, the second light source IS52, and the third light source IS53 finally all exit the light deflection element P5 from the exit surface S58, that is, the lights from the first light source IS51, the second light source IS52, and the third light source IS53 are combined and then exit the light deflection element P5 from the exit surface S58, then enter the third lens L53, and finally are projected on a screen (not shown). The light deflection element P5 mentioned above is a prism.

According to the foregoing, wherein: the first lens L51 is a meniscus lens, wherein the light source side surface S53 is a concave surface; the second lens L52 is a meniscus lens, wherein the light source side surface S55 is a convex surface; the third lens L53 is a meniscus lens, wherein the light source side surface S57 is a concave surface; the first incident surface S59, the second incident surface S510, the third incident surface S511, the exit surface S58, the first inclined surface IP51, and the second inclined surface IP52 of the light deflection element P5 are all plane surfaces; the light source side surface S53 of the first lens L51 includes two inflection points; the projection side surface S54 and light source side surface S55 of the second lens L52 includes two inflection points, respectively; the projection side surface S56 and light source side surface S57 of the third lens L53 includes two inflection points, respectively. With the above design and at least one of the conditions (1)-(13) are satisfied, the projection lens assembly 5 can have an effective increased field of view, an effective decreased volume, an effective decreased F-number, an effective increased resolution, an effective corrected aberration, and an effective increased the light transmission efficiency and overall brightness and saved the energy.

Table 10 shows the optical specification of the projection lens assembly 5 in FIG. 10.

TABLE 10
Effective Focal Length = 4.600 mm F-number = 1.316
Total Lens Length = 7.500 mm Field of View = 31.300 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S51 | ∞ | 0 | | | | ST5 |
| S52 | 2.71797 | 1.05690 | 1.545 | 55.987 | 5.741 | L51 |
| S53 | 17.20442 | 1.12106 | | | | |
| S54 | −1.01978 | 0.50000 | 1.661 | 20.401 | −3.261 | L52 |
| S55 | −2.28196 | 0.27807 | | | | |
| S56 | 1.09263 | 0.69216 | 1.545 | 55.987 | 2.846 | L53 |
| S57 | 2.83067 | 0.50539 | | | | |
| S58 | ∞ | 3.0000 | 1.517 | 64.167 | | P5 |
| S59 | ∞ | 0.3464 | | | | |

The definition of aspheric surface sag z of each aspheric surface in Table 10 is the same as that of in Table 1, and is not described here again.

In the fifth embodiment, the conic constant k and the aspheric coefficients A, B, C, D of each aspheric lens are shown in Table 11.

TABLE 11

| Surface | | | | | |
|---|---|---|---|---|---|
| Number | k | A | B | C | D |
| S52 | −2.430 | 4.6787E−03 | 2.8847E−03 | −5.9459E−04 | −1.0565E−05 |
| S53 | 73.513 | −2.3754E−02 | 1.3151E−02 | −4.8597E−03 | 6.0078E−04 |
| S54 | −2.950 | 1.6082E−02 | −1.3111E−02 | 4.6628E−03 | −3.0522E−04 |
| S55 | −3.894 | −1.4761E−02 | 7.3918E−03 | −2.0707E−03 | 5.2498E−04 |
| S56 | −2.546 | 4.9748E−02 | −1.1863E−02 | −5.7443E−03 | 7.5401E−04 |
| S57 | 0.650 | 5.9582E−02 | −5.7275E−02 | 1.0050E−02 | −9.2971E−04 |

Table 12 shows the parameters and condition values for conditions (1)-(13) in accordance with the fifth embodiment of the invention. It can be seen from Table 12 that the projection lens assembly 5 of the fifth embodiment satisfies the conditions (1)-(13).

TABLE 12

| BFL | 3.8518 mm | HIMGH | 1.260 | mm | TR11R32 | 3.6482 | m |
|---|---|---|---|---|---|---|---|
| f1/f | 1.25 | f1/f3 | 2.02 | | f3/f | 0.62 | |
| BFL/f | 0.84 | BFL/TTL | 0.51 | | TTL/f | 1.63 | |
| (f × TTL)/(f1 × f3) | 2.11 | f × TTL/HIMGH | 27.38 | mm | (f × f)/TR11R32 | 5.80 | mm |

| \|(R11 + R32)/f\| | 1.21 | TTL × f × f3 | 98.17 | (FOV × BFL/f1) × | 733.89 |
|---|---|---|---|---|---|
| | | | | (FOV × TR11R32) | |
| TR12R21/log(f) | 1.692 | TR12R21 | 1.121 | | |

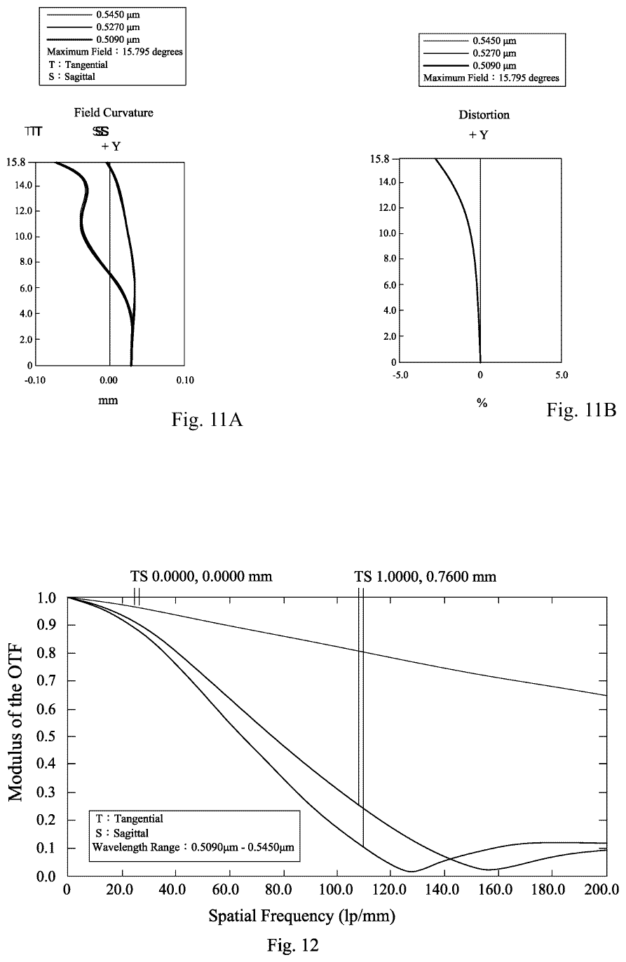

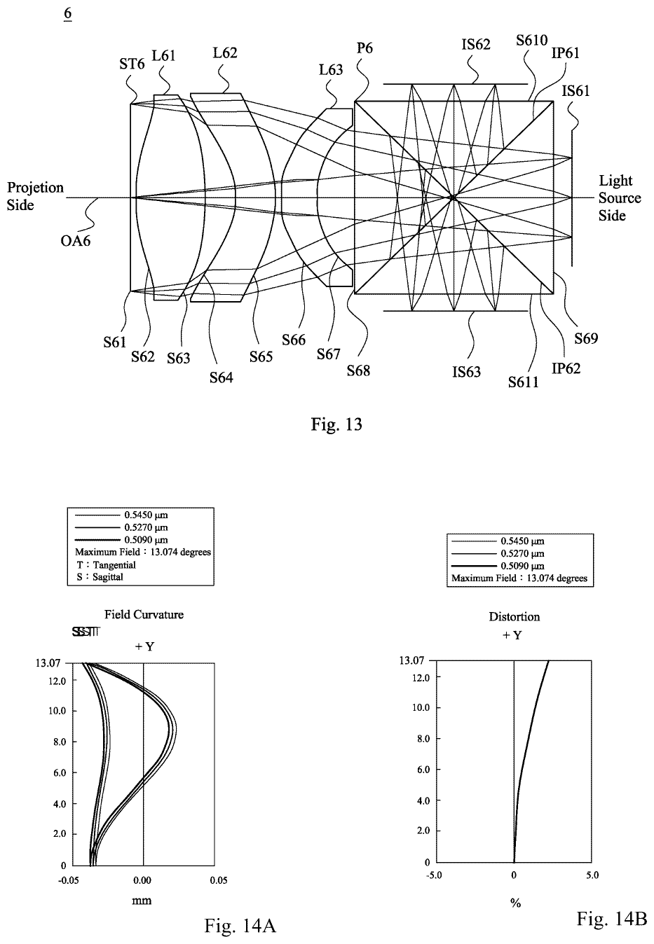

In addition, the projection lens assembly 5 of the fifth embodiment can meet the requirements of optical performance. It can be seen from FIGS. 11A and 11B that the field curvature of tangential direction and sagittal direction ranges from −0.08 mm to 0.04 mm and the distortion ranges from −3% to 0% for the projection lens assembly 5 of the fifth embodiment. It can be seen from FIG. 12 that the modulation transfer function ranges from 0.02 to 1.0 for the projection lens assembly 5 of the fifth embodiment. It is obvious that the field curvature and the distortion can be corrected effectively and the resolution can also meet the requirements for the projection lens assembly 5 of the fifth embodiment. Therefore, the projection lens assembly 5 of the fifth embodiment is capable of good optical performance.

A detailed description of a projection lens assembly in accordance with a sixth embodiment of the invention is as follows. Referring to FIG. 13, the projection lens assembly 6 includes a stop ST6, a first lens L61, a second lens L62, a third lens L63, and a light deflection element P6, all of which are arranged in order from a projection side to a light source side along an optical axis OA6. The light deflection element P6 includes a first incident surface S69, a second incident surface S610, a third incident surface S611, an exit surface S68, a first inclined surface IP61, and a second inclined surface IP62. In operation, the lights from the light sources IS61, IS62, and IS63 enter the light deflection element P6 from the first incident surface S69, the second incident surface S610, and the third incident surface S611, respectively. The light from the light source IS61 directly penetrates the first inclined surface IP61 and the second inclined surface IP62, the light from the light source IS62 is reflected by the first inclined surface IP61 and can penetrate the second inclined surface IP62, the light from the light source IS63 is reflected by the second inclined surface IP62 and can penetrate the first inclined surface IP61. The lights from the first light source IS61, the second light source IS62, and the third light source IS63 finally all exit the light deflection element P6 from the exit surface S68, that is, the lights from the first light source IS61, the second light source IS62, and the third light source IS63 are combined and then exit the light deflection element P6 from the exit surface S68, then enter the third lens L63, and finally are projected on a screen (not shown). The light deflection element P6 mentioned above is a prism.

According to the foregoing, wherein: the first lens L61 is a biconvex lens, wherein the light source side surface S63 is a convex surface; the second lens L62 is a meniscus lens, wherein the light source side surface S65 is a convex surface; the third lens L63 is a meniscus lens, wherein the light source side surface S67 is a concave surface; the first incident surface S69, the second incident surface S610, the third incident surface S611, the exit surface S68, the first inclined surface IP61, and the second inclined surface IP62 of the light deflection element P6 are all plane surfaces. With the above design and at least one of the conditions (1)-(13) are satisfied, the projection lens assembly 6 can have an effective increased field of view, an effective decreased volume, an effective decreased F-number, an effective increased resolution, an effective corrected aberration, and an effective increased the light transmission efficiency and overall brightness and saved the energy.

Table 13 shows the optical specification of the projection lens assembly 6 in FIG. 13.

TABLE 13
Effective Focal Length = 5.300 mm F-number = 1.532
Total Lens Length = 7.000 mm (8 mm, Include Stop) Field of View = 26.000 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S61 | ∞ | 0.1 | | | | ST6 |
| S62 | 3.85379 | 1.26211 | 1.545 | 55.987 | 3.996 | L61 |
| S63 | −4.48622 | 0.54133 | | | | |
| S64 | −1.41655 | 0.72473 | 1.661 | 20.401 | −8.315 | L62 |
| S65 | −2.28744 | 0.10000 | | | | |
| S66 | 1.90627 | 0.65393 | 1.545 | 55.987 | 16.885 | L63 |
| S67 | 2.10922 | 0.67902 | | | | |
| S68 | ∞ | 3.6000 | 1.517 | 64.167 | | P6 |
| S69 | ∞ | 0.3389 | | | | |

The definition of aspheric surface sag z of each aspheric surface in Table 13 is the same as that of in Table 1, and is not described here again.

In the sixth embodiment, the conic constant k and the aspheric coefficients A, B, C, D of each aspheric lens are shown in Table 14.

TABLE 14

| Surface | | | | | |
|---|---|---|---|---|---|
| Number | k | A | B | C | D |
| S62 | −2.491 | 3.1902E−03 | −8.3243E−04 | 2.6034E−05 | −1.9446E−04 |
| S63 | −1.778 | −1.1029E−03 | −4.0693E−04 | −8.7597E−04 | 1.2264E−04 |
| S64 | −0.978 | 4.7543E−02 | −5.0665E−03 | 4.5904E−05 | 1.3863E−04 |
| S65 | −0.648 | 1.1583E−02 | 4.1723E−03 | −8.7430E−04 | 6.3332E−05 |
| S66 | −1.200 | 3.0922E−02 | −9.4059E−03 | 2.7973E−03 | −4.6324E−04 |
| S67 | 0.582 | 7.8815E−02 | −5.1289E−02 | 2.2255E−02 | −5.0623E−03 |

Table 15 shows the parameters and condition values for conditions (1)-(13) in accordance with the sixth embodiment of the invention. It can be seen from Table 15 that the projection lens assembly 6 of the sixth embodiment satisfies the conditions (1)-(13).

TABLE 15

| BFL | 4.6179 mm | HIMGH | 1.260 | mm | TR11R32 | 3.2821 | mm |
|---|---|---|---|---|---|---|---|
| f1/f | 0.75 | f1/f3 | 0.24 | | f3/f | 3.19 | |
| BFL/f | 0.87 | BFL/TTL | 0.58 | | TTL/f | 1.51 | |
| (f × TTL)/(f1 × f3) | 0.63 | f × TTL/HIMGH | 33.65 | mm | (f × f)/TR11R32 | 8.56 | mm |

| \|(R11 + R32)/f\| | 1.13 | TTL × f × f3 | 715.93 | (FOV × BFL/f1) × | 879.73 |
|---|---|---|---|---|---|
| | | | | (FOV + TR11R32) | |
| TR12R21/log(f) | 0.747 | TR12R21 | 0.541 | | |

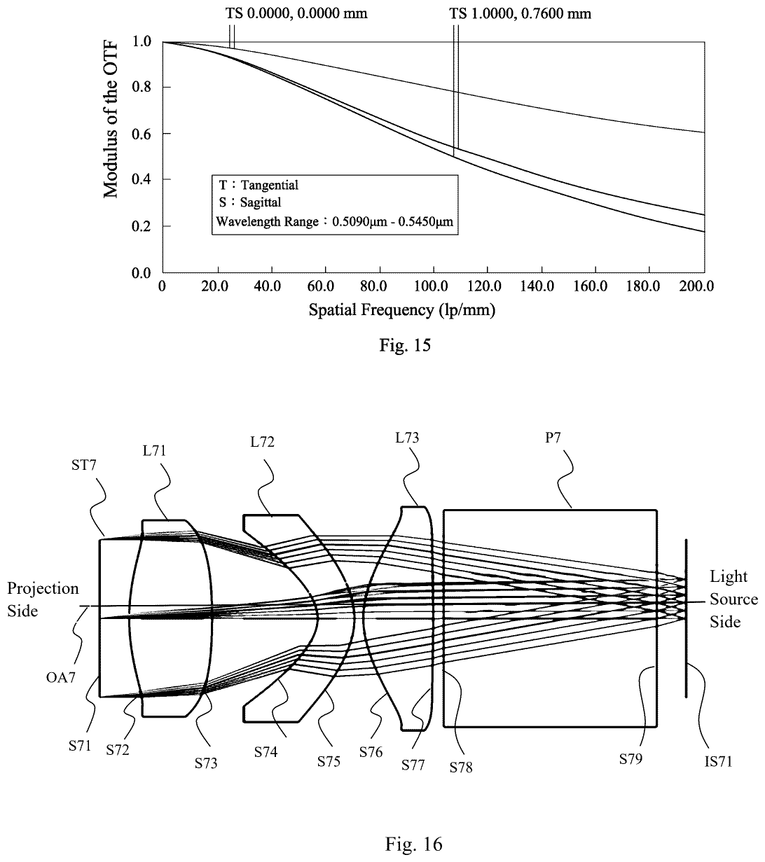

In addition, the projection lens assembly 6 of the sixth embodiment can meet the requirements of optical performance. It can be seen from FIGS. 14A and 14B that the field curvature of tangential direction and sagittal direction ranges from −0.045 mm to 0.025 mm and the distortion ranges from 0% to 2.5% for the projection lens assembly 6 of the sixth embodiment. It can be seen from FIG. 15 that the modulation transfer function ranges from 0.18 to 1.0 for the projection lens assembly 6 of the sixth embodiment. It is obvious that the field curvature and the distortion can be corrected effectively and the resolution can also meet the requirements for the projection lens assembly 6 of the sixth embodiment. Therefore, the projection lens assembly 6 of the sixth embodiment is capable of good optical performance.

In the projection lens assemblies of the second to sixth embodiments mentioned above, the image quality can be increased when the condition 0.7≤f1/f3≤1.0 is further satisfied; the F-number is decreased, the stop diameter is enlarged, and the image brightness is increased when the condition 1.8≤f1/f3≤5.1 is further satisfied; the image quality is increased, the F-number is decreased, and the stop diameter is enlarged when a high refractive index material (Nd>1.5) is used; and the projection lens assemblies can be applied to projection products depending on requirements such as micro projectors and head-mounted displays.

The following embodiments are projection lens assemblies which are similar to the projection lens assemblies of the first to sixth embodiments mentioned above (not pictured).

In another embodiment, there is only one light source and it is only disposed on one of the first incident surface, the second incident surface, or the third incident surface; In operation, the optical path of the light can be the same as that described in one of the light sources in the second to sixth embodiments, or when the light source is disposed on the first incident surface, that is, a side of the prism away from the third lens, the light is reflected by an inclined surface of the prism to the second incident surface, then reflected by the second incident surface and passes through the inclined surface to enter the third incident surface, then reflected by the third incident surface to the inclined surface, and finally reflected by the inclined surface and exits the prism from the exit surface; when it is set on the second incident surface, that is, set on a side of the prism away from the optical axis, the light of the light source can pass through the inclined surface to enter the third incident surface, and then be reflected by the third incident surface and return to the inclined surface, and finally reflected by the inclined surface and exits the prism from the exit surface; or when the light source is disposed on the third incident surface, the light passes through an inclined surface, the second incident surface, the inclined surface, and the exit surface in sequence. In another embodiment, two light sources are provided, wherein one light source is disposed on the second incident surface and the other light source is disposed on the third incident surface, so that the two light sources are parallel to each other. At this time, the light of the light source may be colored light and the light of the other light source may be image light. For example, the light source disposed on the second incident surface is a colored light and the light source disposed on the third incident surface is an image light, then after the colored light is incident on the prism, it passes through an inclined surface and enters the other light source disposed on the third incident surface and is reflected by the other light source disposed on the third incident surface to become the image light, and then is reflected by the inclined surface and exits the prism from the exit surface. In another embodiment, two light sources are provided, wherein one light source is disposed at the first incident surface and the other light source is disposed at the second incident surface or the third incident surface, so that the two light sources are perpendicular to each other. In operation, the light paths of the two lights of the two light sources are the same as described in the second to sixth embodiments and is not described in detail again.

In another embodiment, the stop may not be provided. For example, when the projection lens assemblies of the present invention are used with a screen set, the screen set is provided with a shading element such as a stop. Taking a light guide as an example of the screen set, the light guide may be provided with a shading element. In another embodiment, the stop may be disposed between the first lens and the second lens, or between the second lens and the third lens.

In yet another embodiment, the light deflection elements in the second to sixth embodiments are removed, and the parameters of the remaining stop, the first lens, the second lens, and the third lens are unchanged. At this time, due to the change in the focal position, the TTL and BFL values are different from that of in the second to sixth embodiments. Table 16 shows the TTL and BFL values and their related condition values after the light redirection elements are removed in the second to sixth embodiments.

TABLE 16

| Corresponding | | | | | |
|---|---|---|---|---|---|
| embodiment | | | | | |
| (Remove the | | | | | |
| light redirection | | | | | |
| assembly) | 2 | 3 | 4 | 5 | 6 |
| TTL, BFL | TTL = 6.164 | TTL = 6.153 | TTL = 6.657 | TTL = 6.400 | TTL = 6.582 |
| (mm) | BFL = 3.192 | BFL = 3.140 | BFL = 2.607 | BFL = 2.752 | BFL = 3.300 |
| BFL/f | 0.602 | 0.593 | 0.672 | 0.598 | 0.623 |
| BFL/TTL | 0.518 | 0.510 | 0.392 | 0.430 | 0.501 |
| TTL/f | 1.163 | 1.161 | 1.716 | 1.391 | 1.242 |
| (f × TTL)/(f1 × f3) | 1.032 | 1.144 | 1.724 | 1.802 | 0.517 |
| f × TTL/HIMGH | 28.921 | 25.877 | 31.119 | 23.366 | 27.687 |

The light deflection assembly described in each embodiment of the projection lens assemblies of the present invention can be replaced by a prism, a reflective mirror, a polarization beam prism, a beam combining prism (X-cube Prisms), a polygonal prism, or a curved mirror, and the inclined surface reflecting the light in the light deflection element is not limited to two surfaces, can also be only one surface.

A detailed description of a projection lens assembly in accordance with a seventh embodiment of the invention is as follows. Referring to FIG. 16, the projection lens assembly 7 includes a stop ST7, a first lens L71, a second lens L72, a third lens L73, and a light deflection element P7, all of which are arranged in order from a projection side to a light source side along an optical axis OA7. The light deflection element P7 includes an incident surface S79 and an exit surface S78. In operation, the light from the light source IS71 is incident on the light deflection element P7 through the incident surface S79, passes through the light deflection element P7 and exits the light deflection element P7 from the exit surface S78, then incident on the third lens L73, and finally projected on a screen (not shown). The light deflection element P7 mentioned above is a prism.

According to the foregoing, wherein: the first lens L71 is a biconvex lens, wherein the light source side surface S73 is a convex surface; the second lens L72 is a meniscus lens, wherein the light source side surface S75 is a convex surface; the third lens L73 is a meniscus lens, wherein the light source side surface S77 is a concave surface; both of the incident surface S79 and exit surface S78 of the light deflection element P7 are plane surfaces. With the above design and at least one of the conditions (1)-(13) are satisfied, the projection lens assembly 7 can have an effective increased field of view, an effective decreased volume, an effective decreased F-number, an effective increased resolution, an effective corrected aberration, and an effective increased the light transmission efficiency and overall brightness and saved the energy.

Table 17 shows the optical specification of the projection lens assembly 7 in FIG. 16.

TABLE 17
Effective Focal Length = 5.200 mm F-number = 1.75
Total Lens Length = 9.900 mm Field of View = 32 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S71 | ∞ | 0.5 | | | | ST7 |
| S72 | 4.35848 | 1.40003 | 1.545 | 55.987 | 5.804 | L71 |
| S73 | −10.43701 | 1.78365 | | | | |
| S74 | −0.75554 | 0.62101 | 1.661 | 20.401 | −3.408 | L72 |
| S75 | −1.49972 | 0.15000 | | | | |
| S76 | 1.88978 | 1.18086 | 1.545 | 55.987 | 3.256 | L73 |
| S77 | −24.89217 | 0.17639 | | | | |
| S78 | ∞ | 0.5000 | 1.517 | 64.167 | | P7 |
| S79 | ∞ | 0.0000 | | | | |

The definition of aspheric surface sag z of each aspheric surface in Table 17 is the same as that of in Table 1, and is not described here again.

In the seventh embodiment, the conic constant k and the aspheric coefficients A, B, C, D of each aspheric lens are shown in Table 18.

TABLE 18

| Surface | | | | | |
|---|---|---|---|---|---|
| Number | k | A | B | C | D |
| S72 | −33.695 | 3.8412E−02 | −2.1447E−02 | 6.3142E−03 | −1.0680E−03 |
| S73 | 21.796 | −7.5494E−03 | −2.9049E−03 | 8.8546E−05 | −4.5587E−05 |
| S74 | −2.077 | −3.6103E−02 | −5.9582E−03 | 6.5048E−03 | −1.2295E−03 |
| S75 | −3.794 | −2.1601E−02 | −5.7604E−04 | 1.3657E−03 | −1.4911E−04 |
| S76 | −2.409 | −2.7361E−02 | 1.4880E−02 | −4.7198E−03 | 8.3119E−04 |
| S77 | 34.093 | 6.4109E−03 | 7.0295E−04 | −3.8236E−04 | −4.5400E−05 |

Table 19 shows the parameters and condition values for conditions (1)-(13) in accordance with the seventh embodiment of the invention. It can be seen from Table 19 that the projection lens assembly 7 of the seventh embodiment satisfies the conditions (1)-(13).

TABLE 19

| BFL | 4.276 mm | HIMGH | 1.500 | mm | TR11R32 | 5.1355 | mm |
|---|---|---|---|---|---|---|---|
| f1/f | 1.116 | f1/f3 | 1.78 | | f3/f | 0.626 | |
| BFL/f | 0.822 | BFL/TTL | 0.432 | | TTL/f | 1.904 | |
| (f × TTL)/(f1 × f3) | 2.724 | f × TTL/HIMGH | 34.32 | mm | (f × f)/TR11R32 | 5.265 | mm |

| \|(R11 + R32)/f\| | 3.949 | TTL × f × f3 | 167.59 | (FOV × BFL/f1) × | 875.55 |
|---|---|---|---|---|---|
| | | | | (FOV + TR11R32) | |
| TR12R21/log(f) | 2.491 | TR12R21 | 1.784 | | |

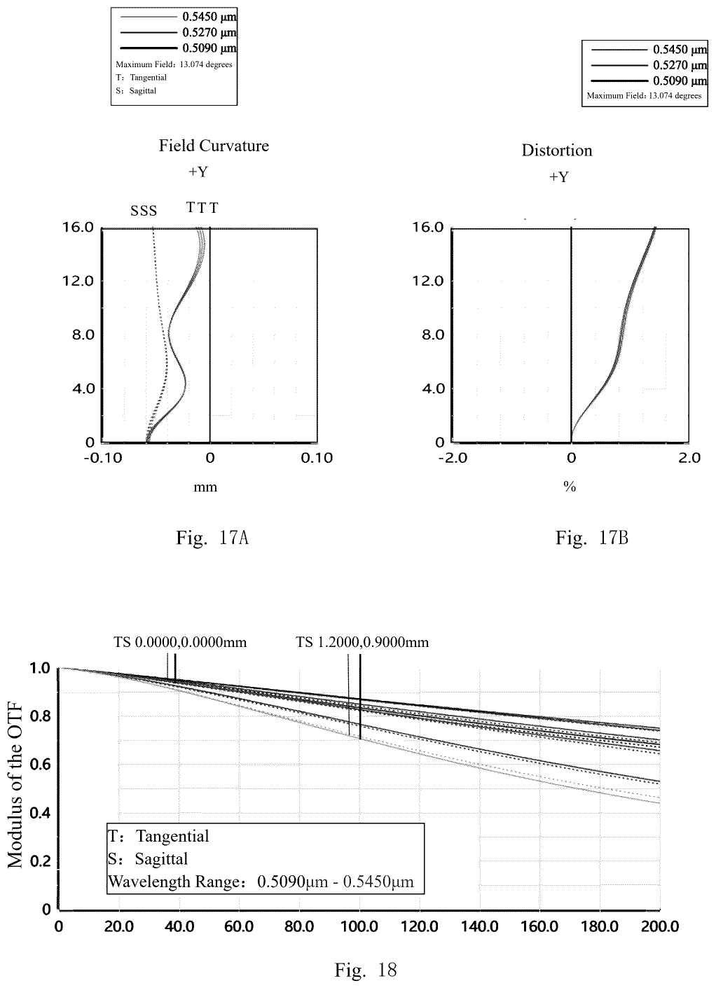

In addition, the projection lens assembly 7 of the seventh embodiment can meet the requirements of optical performance. It can be seen from FIGS. 17A and 17B that the field curvature of tangential direction and sagittal direction ranges from −0.050 mm to 0.000 mm and the distortion ranges from 0% to 2.0% for the projection lens assembly 7 of the seventh embodiment. It can be seen from FIG. 18 that the modulation transfer function ranges from 0.40 to 1.0 for the projection lens assembly 7 of the seventh embodiment. It is obvious that the field curvature and the distortion can be corrected effectively and the resolution can also meet the requirements for the projection lens assembly 7 of the seventh embodiment. Therefore, the projection lens assembly 7 of the seventh embodiment is capable of good optical performance.

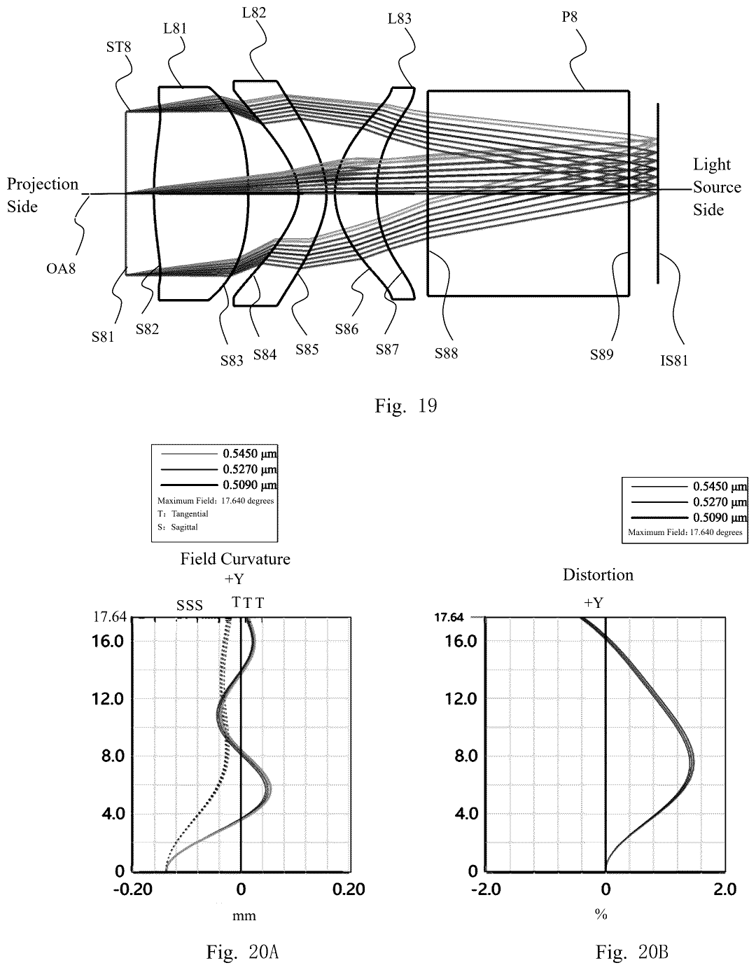

A detailed description of a projection lens assembly in accordance with an eighth embodiment of the invention is as follows. Referring to FIG. 19, the projection lens assembly 8 includes a stop ST8, a first lens L81, a second lens L82, a third lens L83, and a light deflection element P8, all of which are arranged in order from a projection side to a light source side along an optical axis OA8. The light deflection element P8 includes an incident surface S89 and an exit surface S88. In operation, the light from the light source IS81 is incident on the light deflection element P8 through the incident surface S89, passes through the light deflection element P8, and exits the light deflection element P8 from the exit surface S88, then incident on the third lens L83, and finally projected on a screen (not shown). The light deflection element P8 mentioned above is a prism.

According to the foregoing, wherein: the first lens L81 is a biconvex lens, wherein the light source side surface S83 is a convex surface; the second lens L82 is a meniscus lens, wherein the light source side surface S85 is a convex surface; the third lens L83 is a meniscus lens, wherein the light source side surface S88 is a concave surface; both of the incident surface S89 and exit surface S88 of the light deflection element P8 are plane surfaces. With the above design and at least one of the conditions (1)-(13) are satisfied, the projection lens assembly 8 can have an effective increased field of view, an effective decreased volume, an effective decreased F-number, an effective increased resolution, an effective corrected aberration, and an effective increased the light transmission efficiency and overall brightness and saved the energy.

Table 20 shows the optical specification of the projection lens assembly 8 in FIG. 19.

TABLE 20
Effective Focal Length = 5.200 mm F-number = 1.85
Total Lens Length = 9.900 mm Field of View = 32 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S81 | ∞ | 0.5 | | | | ST8 |
| S82 | 5.81003 | 1.69057 | 1.545 | 55.987 | 5.747 | L81 |
| S83 | −6.17171 | 0.89860 | | | | |
| S84 | −0.82608 | 0.50000 | 1.661 | 20.401 | −4.844 | L82 |
| S85 | −1.37609 | 0.15000 | | | | |
| S86 | 1.37242 | 0.74362 | 1.545 | 55.987 | 4.412 | L83 |
| S87 | 2.56507 | 0.91550 | | | | |
| S88 | ∞ | 3.6000 | 1.517 | 64.167 | | P8 |
| S89 | ∞ | 0.5132 | | | | |

The definition of aspheric surface sag z of each aspheric surface in Table 20 is the same as that of in Table 1, and is not described here again.

In the eighth embodiment, the conic constant k and the aspheric coefficients A, B, C, D of each aspheric lens are shown in Table 21.

TABLE 21

| Surface | | | | | |
|---|---|---|---|---|---|
| Number | k | A | B | C | D |
| S82 | −47.391 | 1.6936E−02 | −1.2884E−02 | 3.4219E−03 | −6.8882E−04 |
| S83 | 6.076 | −2.1633E−02 | −8.8938E−04 | 2.7557E−04 | −3.5503E−06 |
| S84 | −2.694 | −1.1363E−02 | −1.0006E−02 | 5.0740E−03 | −6.6009E−04 |
| S85 | −4.828 | −1.2575E−02 | −2.4040E−03 | 1.4251E−03 | −1.0464E−04 |
| S86 | −1.270 | −2.2383E−02 | 1.5247E−02 | −3.1458E−03 | −2.1804E−04 |
| S87 | −7.968 | 6.0326E−02 | −4.6218E−03 | −1.5611E−03 | −5.2033E−04 |

Table 22 shows the parameters and condition values for conditions (1)-(13) in accordance with the eighth embodiment of the invention. It can be seen from Table 22 that the projection lens assembly 8 of the eighth embodiment satisfies the conditions (1)-(13).

TABLE 22

| BFL | 5.029 mm | HIMGH | 1.640 | mm | TR11R32 | 3.98 | mm |
|---|---|---|---|---|---|---|---|
| f1/f | 1.110 | f1/f3 | 1.303 | | f3/f | 0.852 | |
| BFL/f | 0.971 | BFL/TTL | 0.529 | | TTL/f | 1.834 | |
| (f × TTL)/(f1 × f3) | 1.941 | f × TTL/HIMGH | 30 | mm | (f × f)/TR11R32 | 6.737 | mm |

| \|(R11 + R32)/f\| | 1.617 | TTL × f × f3 | 205.93 | (FOV × BFL/f1) × | 885.47 |
|---|---|---|---|---|---|
| | | | | (FOV + TR11R32) | |
| TR12R21/log(f) | 1.258 | TR12R21 | 0.899 | | |

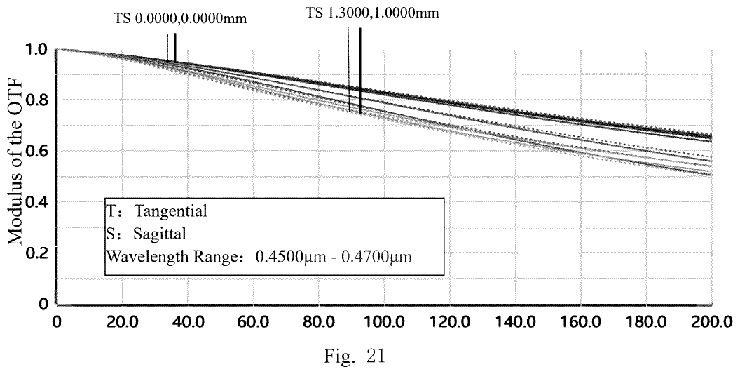

In addition, the projection lens assembly 8 of the eighth embodiment can meet the requirements of optical performance. It can be seen from FIGS. 20A and 20B that the field curvature of tangential direction and sagittal direction ranges from −0.020 mm to 0.015 mm and the distortion ranges from −0.5% to 1.5% for the projection lens assembly 8 of the eighth embodiment. It can be seen from FIG. 21 that the modulation transfer function ranges from 0.50 to 1.0 for the projection lens assembly 8 of the eighth embodiment. It is obvious that the field curvature and the distortion can be corrected effectively and the resolution can also meet the requirements for the projection lens assembly 8 of the eighth embodiment. Therefore, the projection lens assembly 8 of the eighth embodiment is capable of good optical performance.

In the projection lens assemblies of the second to eighth embodiments mentioned above, the image quality can be increased when the condition: 0.8≤f1/f3≤1.0 is further satisfied; the F-number is decreased, the stop diameter is enlarged, and the image brightness is increased when the condition: 1.8≤f1/f3≤5.1 is further satisfied; the image quality is increased, the F-number is decreased, and the stop diameter is enlarged when a high refractive index material (Nd>1.5) is used; and the projection lens assemblies can be applied to projection products depending on requirements such as micro projectors and head-mounted displays.

In another embodiment, the light deflection elements in the seventh to eighth embodiments are removed, and the parameters of the remaining stop, the first lens, the second lens and the third lens are unchanged. At this time, due to the change in the focal position, the TTL and BFL values are different from that of in the seventh to eighth embodiments. Table 23 shows the TTL and BFL values and their related condition values after the light redirection elements are removed in the seventh to eighth embodiments.

TABLE 23

| Corresponding embodiment | | |
|---|---|---|
| (Remove the light | | |
| redirection assembly) | 7 | 8 |
| TTL, BFL | TTL = 8.64 | TTL = 8.21 |
| (mm) | BFL = 4.58 | BFL = 3.73 |
| BFL/f | 0.881 | 0.72 |
| BFL/TTL | 0.487 | 0.414 |
| TTL/f | 1.81 | 1.74 |
| (f × TTL)/(f1 × f3) | 2.59 | 1.841 |
| f × TTL/HIMGH | 32.628 | 28.463 |

The convex surface or the concave surface of any one of the lens is the shape near the optical axis.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projection lens assembly comprising:
a first lens which is with positive refractive power and comprises a convex surface facing a projection side;
a second lens which is with negative refractive power and comprises a concave surface facing the projection side; and
a third lens which is with positive refractive power and comprises a convex surface facing the projection side;
wherein the first lens, the second lens, and the third lens are arranged in order from the projection side to a light source side along an optical axis;
wherein the projection lens assembly satisfies at least one of following conditions:
$$\begin{matrix}\begin{matrix}\begin{matrix}18 mm \leq f \times TTL / HIMGH \leq 45 mm ; \\ 3 mm \leq ( f \times f ) / TR 11 R 32 \leq 11 mm ;\end{matrix} \\ 0.6 \leq \vert ( R 11 + R 32 ) / f \vert \leq 5 ;\end{matrix} \\ TR 11 R 32 / 2 > TR 12 R 21 / log ( f ) > TR 12 R 21 ;\end{matrix}$$
wherein f is an effective focal length of the projection lens assembly, TTL is an interval from a projection side surface of the first lens to a light source along the optical axis, HIMGH is a half image height of the projection lens assembly, TR11R32 is an interval from the projection side surface of the first lens to a light source side surface of the third lens along the optical axis, R11 is a radius of curvature of the projection side surface of the first lens, R32 is a radius of curvature of the light source side surface of the third lens, and TR12R21 is an interval from a light source side surface of the first lens to a projection side surface of the second lens along the optical axis.

2. The projection lens assembly as claimed in claim 1, wherein the projection lens assembly satisfies at least one of following conditions:
$$\begin{matrix}\begin{matrix}\begin{matrix}\begin{matrix}\begin{matrix}\begin{matrix}\begin{matrix}\begin{matrix}0.6 \leq f 1 / f \leq 2.6 ; \\ 0.3 \leq f 3 / f \leq 3.9 ;\end{matrix} \\ 0.7 \leq f 1 / f 3 \leq 5.1 ;\end{matrix} \\ 0.4 \leq BFL / f \leq 1.3 ;\end{matrix} \\ 0.3 \leq BFL / TTL \leq 0.8 ;\end{matrix} \\ 0.9 \leq TTL / f \leq 2.5 ;\end{matrix} \\ 0.4 \leq ( f \times TTL ) / ( f 1 \times f 3 ) \leq 2.6 ;\end{matrix} \\ TTL \times f \times f 3 < ( FOV \times BFL / f 1 ) \times ( FOV + TR 11 R 32 ) ;\end{matrix} \\ ( f 1 / f ) \times 3 > fno ;\end{matrix}$$
wherein f is the effective focal length of the projection lens assembly, f1 is an effective focal length of the first lens, f3 is an effective focal length of the third lens, TTL is the interval from the projection side surface of the first lens to the light source along the optical axis, BFL is an interval from the light source side surface of the third lens to the light source along the optical axis, FOV is a field of view of the projection lens assembly, TR11R32 is the interval from the projection side surface of the first lens to the light source side surface of the third lens along the optical axis, and fno is a F-number of the projection lens assembly.

3. The projection lens assembly as claimed in claim 1, wherein:
at least one of the first lens, the second lens, and the third lens is a meniscus lens;
the first lens or the second lens is a meniscus lens when the number of meniscus lenses is one;
the second lens and the third lens are meniscus lenses when the number of meniscus lenses is two; and
the first lens, the second lens and the third lens are meniscus lenses when the number of meniscus lenses is three.

4. The projection lens assembly as claimed in claim 3, wherein the first lens is a biconvex lens and further comprises another convex surface facing the light source side when the number of meniscus lenses is two.

5. The projection lens assembly as claimed in claim 3, wherein:
the second lens is a biconcave lens and further comprises another concave surface facing the light source side and the third lens is a biconvex lens and further comprises another convex surface facing the light source side when the number of meniscus lenses is one and the first lens is a meniscus lens; and
the first lens is a biconvex lens and further comprises another convex surface facing the light source side and the third lens is a biconvex lens and further comprises another convex surface facing the light source side when the number of meniscus lenses is one and the second lens is a meniscus lens.

6. The projection lens assembly as claimed in claim 3, wherein:
the convex surface of the third lens has an inflection point when the number of meniscus lenses is three; and
a light source side surface of the first lens has an inflection point, a light source side surface of the second lens has an inflection point, and a light source side surface of the third lens has an inflection point when the number of meniscus lenses is one.

7. The projection lens assembly as claimed in claim 6, wherein the projection lens assembly satisfies at least one of following conditions:
$$\begin{matrix}\begin{matrix}\begin{matrix}\begin{matrix}\begin{matrix}\begin{matrix}\begin{matrix}\begin{matrix}0.6 \leq f 1 / f \leq 2.6 ; \\ 0.3 \leq f 3 / f \leq 3.9 ;\end{matrix} \\ 0.7 \leq f 1 / f 3 \leq 5.1 ;\end{matrix} \\ 0.4 \leq BFL / f \leq 1.3 ;\end{matrix} \\ 0.3 \leq BFL / TTL \leq 0.8 ;\end{matrix} \\ 0.9 \leq TTL / f \leq 2.5 ;\end{matrix} \\ 0.4 \leq ( f \times TTL ) / ( f 1 \times f 3 ) \leq 2.6 ;\end{matrix} \\ TTL \times f \times f 3 < ( FOV \times BFL / f 1 ) \times ( FOV + TR 11 R 32 ) ;\end{matrix} \\ ( f 1 / f ) \times 3 > fno ;\end{matrix}$$
wherein f is the effective focal length of the projection lens assembly, f1 is an effective focal length of the first lens, f3 is an effective focal length of the third lens, TTL is the interval from the projection side surface of the first lens to the light source along the optical axis, BFL is an interval from the light source side surface of the third lens to the light source along the optical axis, FOV is a field of view of the projection lens assembly, TR11R32 is the interval from the projection side surface of the first lens to the light source side surface of the third lens along the optical axis, and fno is a F-number of the projection lens assembly.

8. The projection lens assembly as claimed in claim 1, further comprising a light deflection element disposed between the third lens and the light source side.

9. The projection lens assembly as claimed in claim 8, wherein the light deflection element is a polarization beam prism, a beam combining prism, a polygonal prism, a curved mirror, or a reflective mirror.

10. The projection lens assembly as claimed in claim 8, further comprising at least a light source, wherein:
the light source is disposed on a side of the light deflection element which is far away from the optical axis or another side of the light deflection element which is far away from the third lens when the number of light sources is one;
the light sources are separated by the light deflection element and disposed away from the optical axis when the number of light sources is two and the light sources are parallel to each other;
one of the light sources is disposed on the side of the light deflection element which is away from the optical axis, the other of the light sources is disposed on the another side of the light deflection element 12 which is away from the third lens when the number of light sources is two and the light sources are perpendicular to each other; and
one of the light sources is disposed on the another side of the light deflection element which is away from the third lens, the other two of the light sources are parallel to each other, and separated by the light deflection element and disposed away from the optical axis when the number of light sources is three.

11. The projection lens assembly as claimed in claim 10, wherein the projection lens assembly satisfies at least one of following conditions:
$$\begin{matrix}\begin{matrix}\begin{matrix}\begin{matrix}\begin{matrix}\begin{matrix}\begin{matrix}\begin{matrix}0.6 \leq f 1 / f \leq 2.6 ; \\ 0.3 \leq f 3 / f \leq 3.9 ;\end{matrix} \\ 0.7 \leq f 1 / f 3 \leq 5.1 ;\end{matrix} \\ 0.4 \leq BFL / f \leq 1.3 ;\end{matrix} \\ 0.3 \leq BFL / TTL \leq 0.8 ;\end{matrix} \\ 0.9 \leq TTL / f \leq 2.5 ;\end{matrix} \\ 0.4 \leq ( f \times TTL ) / ( f 1 \times f 3 ) \leq 2.6 ;\end{matrix} \\ TTL \times f \times f 3 < ( FOV \times BFL / f 1 ) \times ( FOV + TR 11 R 32 ) ;\end{matrix} \\ ( f 1 / f ) \times 3 > fno ;\end{matrix}$$
wherein f is the effective focal length of the projection lens assembly, f1 is an effective focal length of the first lens, f3 is an effective focal length of the third lens, TTL is the interval from the projection side surface of the first lens to the light source along the optical axis, BFL is an interval from the light source side surface of the third lens to the light source along the optical axis, FOV is a field of view of the projection lens assembly, TR11R32 is the interval from the projection side surface of the first lens to the light source side surface of the third lens along the optical axis, and fno is a F-number of the projection lens assembly.

12. The projection lens assembly as claimed in claim 1, further comprising a stop disposed between the projection side and the first lens.

13. The projection lens assembly as claimed in claim 1, wherein:
the first lens is a meniscus lens and comprises a concave surface facing the light source side;
the second lens is a meniscus lens and comprises a convex surface facing the light source side; and
the third lens is a meniscus lens and comprises a concave surface facing the light source side.

14. The projection lens assembly as claimed in claim 1, wherein the convex surface or the concave surface of any one of the lens is the shape near the optical axis.
